(19) United States
(12) Patent Application Publication
(10) Pub. No.: US 2002/0026410 A1
(43) Pub. Date: Feb. 28, 2002

(54) Paperless online merchant account approval and provisioning system and method therefor

(75) Inventors: Steven Y. Woloshin, Canoga Park, CA (US); Bruce R. Shirey, Agoura Hills, CA (US)

Correspondence Address: Edward G. Poplawski, Esq., SIDLEY & AUSTIN, 555 West Fifth Street, Los Angeles, CA, 90013-1010, US

(73) Assignee: PROSECUTE

(21) Appl. No.: 09/798,057

(22) Filed: Mar. 1, 2001

Related U.S. Application Data
(60) Provisional application No. 60/185,973, filed on Mar. 1, 2000.

(51) Int. Cl. G06F 17/60

(52) U.S. Cl. 705/38

(57) ABSTRACT

The present invention, is an online paperless account approval and provisioning technique and system. Specifically, the invention discloses a method and system for automatically approving an electronic account application (such as a merchant account) of an applicant to establish a valid account and provisioning the account with electronically integrated data systems in order to enable the applicant to provide a service. The method includes capturing account information via an online account application submitted by the applicant; automatically processing the account information using predetermined acceptance criteria; upon acceptance of the predetermined criteria, automatically approving the account; and automatically provisioning the approved account with the integrated data systems using the account information. The invention offers a number of advantages, including: (a) the elimination for the need of a “wet signature;” (b) a reduction in the amount of information needed in a paper application; (c) significant reduction in the time required for account approval or denial; (d) once approved, significant reduction in the provisioning time (the time required to make applicants operational and to enable applicants to offer their services online); (d) the elimination of the human error factor in human review of applications; and (e) permitting auto-approval and auto-provisioning of accounts, whether they be merchant or other types of accounts.

### CROSS-REFERENCE TO RELATED APPLICATION

This application claims the benefit of U.S. Provisional Application No. 60/185,973, filed Mar. 1, 2000.

### FIELD OF THE INVENTION

This invention relates to the field of electronic commerce and more particularly to an online, automatic account acquisition and provisioning system.

### BACKGROUND OF THE INVENTION

Conventional methods of establishing “merchant accounts,” i.e. setting up merchants for accepting credit cards or other established electronic payment vehicles such as debit cards, smart cards, electronic checks or the like, as a method of payment for goods and/or services, involve many relatively costly and time-consuming steps. For example, an applicant must fill out a detailed application form and send it to an approving entity. Traditionally, this application is a paper form that is manually completed, signed in ink (“wet signature”) and mailed to the approving entity. Alternatively, the application may be completed electronically by inputting into various fields presented on a computer screen the required data. The electronic form is then either printed out, signed and mailed or may even be e-mailed to the account approving entity. In all of these scenarios, however, the application is analyzed by one or more individual(s) who, perhaps with the aid of computers, decide(s) whether the applicant is creditworthy.

More recently, semi-automatic approval systems have been developed that can assist in the analysis of electronic account applications. Such systems use pre-approval algorithms that analyze selected data and determine, whether, under pre-established criteria, the applicant is creditworthy. While these algorithms assist somewhat in the approval process, unfortunately, the approval process not fully automated and is thus still relatively costly and lengthy, particularly with respect to low risk and low volume merchant applicants.

Merchants who wish to conduct online sales by accepting one or more established electronic payment vehicles, hereinafter called “online merchants,” must have some mechanism for integrating their merchant accounts with the various systems or entities upon which the merchant accounts are dependant. These entities include, for example, the financial transaction processor (FTP), such as First Data Merchant Services (FDMS), the Internet service providers (ISP's) or commerce service providers (CSP's) that provides online access to the applicant (and may host the merchant that wishes to conduct e-commerce), the agents or sales representatives that offer and sell the merchant accounts, and the payment gateway entity (PGE) that routes all the data. Thus, some or all of these systems or entities use data from the application to create records that are necessary to integrate the process and to ultimately allow the process to work. This is known in the industry as “provisioning.” Provisioning can be a time consuming and rather complex endeavor and adds cost to the merchant account process. It should be understood that as used herein the term “online merchants” is not limited to online merchants that offer goods and/or services on web site storefronts on the Internet. Other real-time, electronic commerce systems are included in the term, including wired and wireless telecommunications (voice and data) systems, and other e-commerce schemes that are known in the art.

It would thus be desirable to have an integrated, paperless, and fully automated online system and method for setting up and approving merchant accounts and for automatically provisioning all the data with the various entities to efficiently and cost-effectively provide such services. It was also be desirable to have a similar system and method for automatically approving and provisioning non-merchant accounts that offers any type of service such as information (e.g. a news providing service).

### SUMMARY OF THE INVENTION

The present invention, which addresses these needs, resides in an online paperless account approval and provisioning technique and system The invention described below has a number of advantages, including: (a) the elimination for the need of a “wet signature;” (b) a reduction in the amount of information needed in a paper application; (c) significant reduction in the time required for account approval or denial; (d) once approved, significant reduction in the provisioning time (the time required to make applicants operational and to enable applicants to offer their services online); (d) the elimination of the human error factor in human review of applications; and (e) permitting auto-approval and auto-provisioning of accounts, whether they be merchant or other tpyes of accounts.

In accordance with the present invention, a method for automatically approving an electronic account application of an applicant to establish a valid account and provisioning the account with electronically integrated data systems in order to enable the applicant to provide a service is disclosed. The method includes capturing account information via an online account application submitted by the applicant; automatically processing the account information using predetermined acceptance criteria; upon acceptance of the predeterimed criteria, automatically approving the account; and automatically provisioning the approved account with the integrated data systems using the account information. More specifically, this last step includes automatically transmitting selected information of the approved account to the data systems. Further, the predetermined acceptance criteria comprises a pre-selected number of primary risk factors.

In a more specific embodiment, the applicant is a merchant and the valid account is a merchant account for accepting an established electronic payment vehicle as payment for goods or services. Examples of established electronic payment vehicles include credit cards, debit cards, smart cards, electronic check, to name a few. In this embodiment, the processing of the merchant account information may include analyzing (i) whether the applicant has an identifiable and valid bank account; (ii) a credit bureau score that identifies whether an actual person with credit history is applying and the credit history of the person; and (iii) whether the expected monthly transaction volume is less than a predetermined monetary threshold.

In yet another embodiment, a method of managing a paperless, online merchant credit card account is disclosed. In particular, the method includes providing a link on a web site to an online merchant application server that serves an online merchant application. The merchant completes or inputs the online application forms with the requested merchant application data and submits the online merchant application forms to a merchant service provider. This data is stored in an application database, is imported to a database application set. Further, the application data is provided to an auto-approval subsystem maintained by the merchant service provider. This subsystem then analyes the application data to determine whether the application will be approved. Upon approval, the approved application is uploaded to a transaction processor to create an approved account record.

A system for electronically and automatically approving and provisioning an account online is also disclosed. This system includes a web-hosting server, such as an ISP or CSP, that hosts and offers the account to a prospective account holder via a web site. Further included is an online application server linked to the web hosting server, having an application landing page, at least one online application form that captures application data, and an application database for storing the application data. An auto-approval subsystem linked to the online application server is also provided. Finally, an online gateway for automatically-provisioning the systems is provided. The account can be a merchant credit card account, a merchant debit card account, a merchant check guarantee service account, a smart card account or any other electronic payment vehicle account.

In a more specific embodiment, the online application includes numerous forms or pages. These pages can include a business information form, a business category description form, a checking account information form and a merchant agreement form. The application may also include a fee schedule review and acceptance form. This inventive system advantageously permits automatic approval and provisioning of the data that is required by all systems that are required to work together (integrate) to provide a service to the applicant.

Other features and advantages of the present invention should become more apparent from the following description of the preferred embodiments, taken in conjunction with the accompanying drawings, which illustrate, by way of example, the principles of the invention.

### BRIEF DESCRIPTION OF THE DRAWINGS

FIG. 1 is an illustrative block diagram showing the primary process flow of the auto-provisioning and auto-approval system of the present invention; and

FIG. 2 is a flow chart describing the information gathered in a typical online application according to the preferred embodiment of the present invention.

### DETAILED DESCRIPTION OF THE PREFERRED EMBODIMENTS

The invention summarized above and defined by the enumerated claims may be better understood by referring to the following detailed description, which should be read in conjunction with the accompanying drawings. This detailed description of particular preferred embodiments, set out below to enable one to build and use particular implementations of the invention, is not intended to limit the enumerated claims, but to serve as a particular examples thereof. The particular example set out below is the preferred specific implementation of a paperless online merchant application procedure, method and system. It should be understood however, that this system is not limited to online auto-provisioning and auto-approval of merchant credit card accounts. Other types of account can be provisioned and approved with the method set forth below.

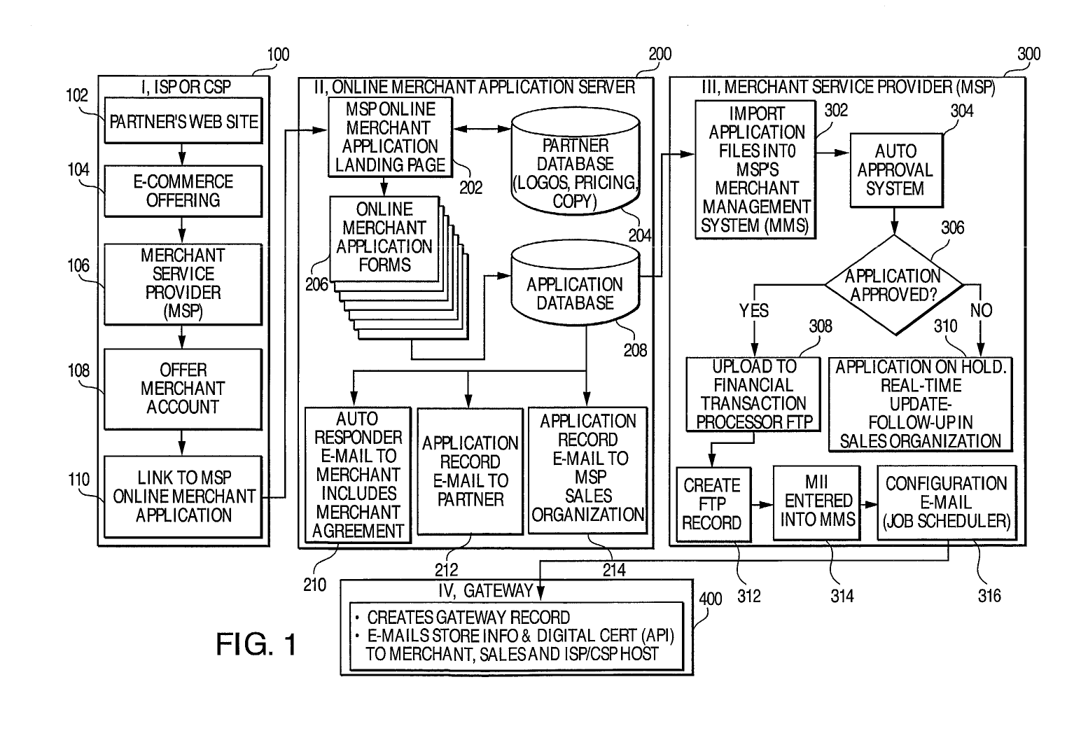

FIG. 1 illustrates the primary process flow and components of the preferred embodiment of the present inventive system. As shown, four systems are integrated to accomplish the task of presenting an online application to a prospective online merchant, processing the application and provisioning the approved account. They are: (1) the ISP or CSP module, 100; (2) the Online Merchant Application Server, 200; (3) the Merchant Service Provider (MSP) module, 300; and (4) the Payment Gateway Entity (PGE) 400.

The process begins at a partner's Web site 102 that is hosted by an ISP or CSP. A partner is an entity that enables merchants to become online merchants. Each partner presents their e-commerce offering 104 to prospective online merchants on their Web site. The e-commerce offering includes an MSP merchant account offer. The partner introduces the MSP 106, offers the merchant the prospect of opening a new “Merchant Account” 108 and provides a link to the MSP's paperless online merchant application 110.

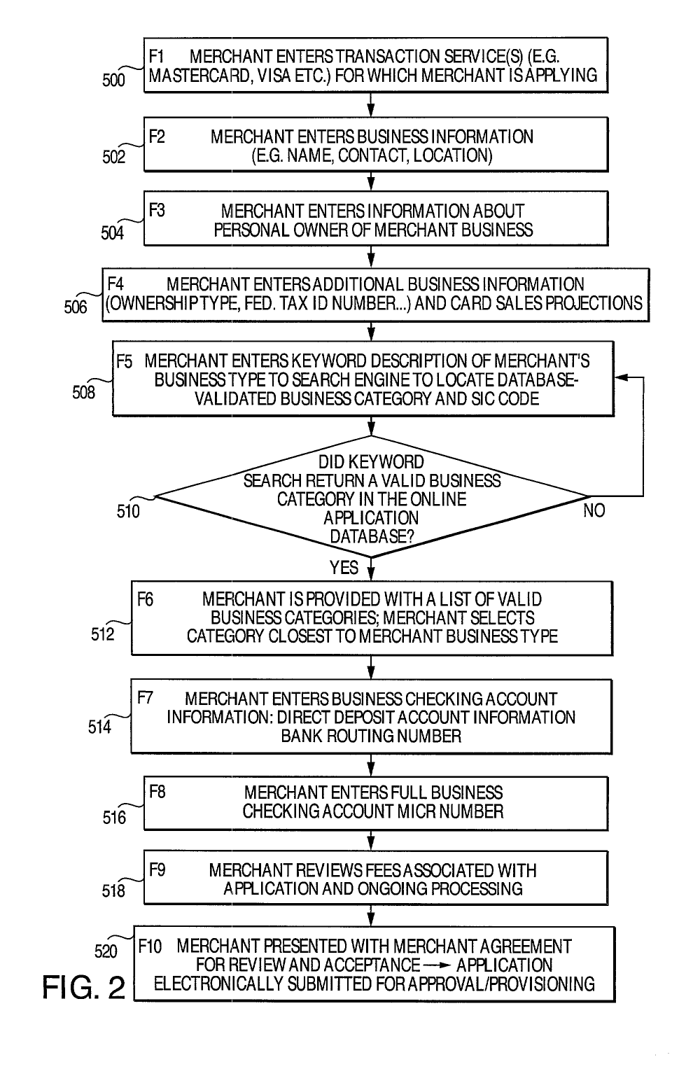

When the merchant, at his/her computer, “clicks” on the link, it is hyperlinked to the MSP's Online Merchant Applications Server's 200 landing page at step 202. The merchant then clicks the “Click Here to Apply” button which opens a new Web browser window containing the multiple forms 206 for the Paperless Online Merchant Application. These forms will be described in more detail with reference to FIG. 2. The partner database 204 contains partner-specific data such as logos, pricing, and customer service contact. When the new browser window opens, the partner-specific data is pulled from the partner database 204 to populate the appropriate fields in the application forms 206. As the merchant completes each form, the data is validated and captured in an application database 208.

In the preferred embodiment, when the merchant completes the Paperless Online Merchant Application, three e-mails are automatically sent. The first e-mail, the “Autoresponder” 210 is sent to the merchant. This e-mail confirms receipt of their application and includes a copy of the MSP merchant agreement for the merchant's reference. The second and third e-mails 212 and 214 are sent to the partner and MSP sales representative, respectively. These e-mails contain data from the application. These two e-mails inform the partner and MSP sales representative that an application has been submitted.

In the preferred embodiment, several times daily, the new account applications are imported from the application database to the MSP system 300 and, more particularly, into a database application set (such as the Foxprom ™ system) 302. The applications then go through the auto-approval process 304.

The auto-approval process entails immediate analysis of data input by the applicant-merchant to essentially determine the risk involved in approving the merchant. The system 304 is a logic-scoring protocol analyzing primary risk criteria. In the preferred embodiment, those criteria include: (1) whether the applicant has an identifiable valid US bank account; (2) a credit bureau score that identifies an actual person with credit history is applying (not necessarily the applicants creditworthiness; and (3) validation that the expected monthly transaction volume is less than a certain dollar value threshold, “$N.” If all conditions are met, the application is automatically approved. It should be understood that other criteria may be used to determine applicant creditworthiness. Creating such a subsystem is well known to those skilled in the art.

After the moving through the auto-approval process 304, the system inquires as to whether the application has, in fact, been approved, 306. In one preferred embodiment, merchant applications submitted by a certain time in the day that transact less than $N in monthly MasterCard and Visa sales volume will be automatically approved the same day. Merchants with monthly MasterCard and Visa sales volumes over $N may be required to provide additional documentation, before or after approval. Applications that cannot be automatically approved, i.e., invalid bank information was provided or no credit bureau record is available, will be placed on hold for follow-up by MSP sales representative and/or Risk Analysis personnel as shown in step 310. The system is designed to enable real-time update to an online sales tracking system (not shown) to enable the sales representative to follow-up and check the status of submitted application. When the hold reason has been resolved, the application will continue through regular processing.

Automatically approved accounts are then ready for provisioning, or more particularly, auto-provisioning. “Auto-provisioning” as used herein refers to the automatic passing of data sets to disparate systems that creates records (or tables or fields of records) of the newly approved account to allow processing to take place. In the preferred embodiment, there are at least three systems that need to be “provisioned,” namely, the financial transaction processor, or “FTP” (such as First Data Corporation—Nashville), the payment gateway entity, or “PGE” (such as LinkPoint International's LinkPoint gateway), and the ISP (or CSP) host. The first step is to upload the account information to the FTP on a daily basis, 308, whereat a processor record 312 is automatically created. Then, at step 314 merchant identification information, such as a Merchant ID (MID) and Terminal ID (TID) are then assigned to each account. This information triggers a Job Scheduler at 316 to send the configuration files (via email in this embodiment) for the new accounts to the PGE at 400.

The new accounts are automatically provisioned on the PGE at 400. In particular, the PGE automatically sends the merchant, the MSP sales representative and ISP or CSP a welcome e-mail for the appropriate gateway product containing instructions on how to begin using the account. Examples of gateway products are LinkPoint International's “Select API”, “LinkPoint™ Basic” and “Virtual LinkPoint™” (VLP) products. See LinkPoint International's web site at “www.linkpoint.com” for a detailed explanation of these products and services. The welcome e-mail for the API contains a digital certificate.

The specific details of the paperless online application forms 206 served to the merchant by the MSP are now described in conjunction with FIG. 2. The application comprises numerous web page forms, which must be completed in succession. The merchant moves to the next form (web page) by completing (filling in) the required data fields or reading the required text on a current form and clicking on a “next” button. In particular, at step 500, the merchant is presented with a “Services Offered” pages (form 1), at which it must identify the type of transaction service(s) for which the merchant is applying. This form may also query the merchant about other card services the merchant may already be using. At step 502 (form 2), the merchant enters and submits merchant business name, contact, and location information. In step 504 (form 3) the merchant is then queried for information concerning the owner of the business. Then, in step 506, form 4 collects various other data relating to the merchant's business, such as the ownership structure, the business tax ID number, the expected average monthly credit card volume and the average dollar value of each transaction. In step 508 (form 5), the merchant is asked to enter one or more keywords that best describes the merchant's business. This data is submitted to a search engine for the immediate identification of a recognized business category into which the merchant's business falls and its appropriate SIC code.

The online application system, at step 510 then queries the search database for one or more recognized business categories that is associated with the keyword(s). If no valid business category is found in the database, the system returns the merchant to step form 5 (step 508) to enter a new keyword for searching in the database. If valid one more categories are returned, a list of those categories is returned in step 512 (form 6), and the merchant/applicant (if more than one category is returned) chooses the category that most closely described the merchant's business.

Next, in steps 514 and 516, the merchant enters its banking information. In particular, at step 514 (online form 7), the merchant enters its business checking account information, including its direct deposit account (DDA) routing number. In step 516, the merchant is presented (on form 8) with its bank name and enters the bank MICR number

Finally, at step 518, the merchant is presented with a screen showing the fees associated with the merchant application and the ongoing processing costs/fees, and at step 520 the merchant is served the Merchant Agreement for reviewing and acceptance, in a manner that is well-known to those skilled in the art and will thus not be discussed in detail.

Having thus described exemplary embodiments of the invention, it will be apparent that further alterations, modifications, and improvements will also occur to those skilled in the art. Further, it will be apparent that the present technique and system is not limited to use with credit card merchant account systems. The technique and system is equally applicable to other established electronic payment vehicles, such as debit cards, electronic checking and other vehicles that are associated with a financial authority, such as a bank.

Moreover, the auto-approval and auto-provisioning system and technique of the present invention may be implemented for other non-financial transaction based services. Such alterations, modifications, and improvements, though not expressly described or mentioned above, are nonetheless intended and implied to be within the spirit and scope of the invention. Accordingly, the foregoing discussion is intended to be illustrative only; the invention is limited and defined only by the various following claims and equivalents thereto.

We claim:

1. A method for automatically approving an electronic account application of an applicant to establish a valid account and provisioning the account with electronically integrated data systems in order to enable the applicant to provide a service, including:
(a) capturing account information via an online account application submitted by the applicant;
(b) automatically processing the account information using predetermined acceptance criteria;
(c) upon acceptance of the predetermined criteria, automatically approving the account; and
(d) automatically provisioning the approved account with the integrated data systems using the account information.

2. The method of claim 1, wherein the step of automatically provisioning includes automatically transmitting selected information of the approved account to the data systems.

3. The method of claim 2, wherein the predetermined acceptance criteria comprises a pre-selected number of primary risk factors.

4. The method of claim 3, wherein the applicant is a merchant and the valid account is a merchant account for accepting an established electronic payment vehicle as payment for goods or services.

5. The method of claim 4, wherein the processing of the merchant account information includes analyzing (i) whether the applicant has an identifiable and valid bank account; (ii) a credit bureau score that identifies whether an actual person with credit history is applying and the credit history of the person; and (iii) whether the expected monthly transaction volume is less than a predetermined monetary threshold.

6. A method of managing a paperless, online merchant credit card account, including:
(a) providing a link on a web site to an online merchant application server that serves an online merchant application;
(b) the merchant submitting the online merchant application forms containing merchant application data;
(c) storing the application data in an application database;
(d) importing the application data to a database application set;
(e) providing the application data to an auto-approval subsystem;
(f) analyzing the application data to determine whether the application will be approved; and
(g) upon approval, uploading the approved application to a transaction processor and creating an approved account record.

7. A system for electronically and automatically approving and provisioning an account online, the system including:
(a) a web-hosting server that hosts and offers the account to a prospective account holder via a web site;
(b) an online application server linked to the web hosting server, having an application landing page, at least one online application form that captures application data, and an application database for storing the application data;
(c) an auto-approval subsystem linked to the online application server; and
(d) an online gateway for automatically-provisioning the systems to provide a service.

8. The system of claim 7 wherein the account at least one of a merchant credit card account, a merchant debit card account, a merchant check guarantee service account and a smart card account.

9. The system of claim 7, wherein the at least one online application form includes
(i) a business information form;
(ii) a business category description form;
(iii) a checking account information form; and
(iv) a merchant agreement form.

10. The system of claim 9, wherein the at least one online application form further includes
(i) a fee schedule review and acceptance form.
